(19) United States
(12) Patent Application Publication
(10) Pub. No.: US 2026/0109009 A1
(43) Pub. Date: Apr. 23, 2026

(54) LOCKING FLEX HAND TOOL

(71) Applicant: Stanley Black & Decker MEA FZE, Dubai (AE)

(72) Inventor: Yun Chung Tu, Taichung City (TW)

(21) Appl. No.: 18/923,639

(22) Filed: Oct. 22, 2024

(30) Foreign Application Priority Data
Oct. 13, 2023 (EP) 23203624.4

(51) Int. Cl. B25B 23/00

(52) U.S. Cl. CPC B25B 23/0028

(57) ABSTRACT

This invention relates to a hand tool having a locking flex head. The hand tool includes a handle, a connecting ratchet having a series of teeth, and a head rotatably secured to the handle and configured to be ratcheted between a first position and a second position.

### CROSS-REFERENCE TO RELATED APPLICATIONS

This application claims priority to EP Patent Application No. 23203624.4, filed on October 13, 2023, which is incorporated herein by reference in its entirety.

### FIELD OF THE INVENTION

The present invention relates to a hand tool. More specifically, a hand tool with a locking flex head.

### BACKGROUND OF THE INVENTION

Hand tools having flexible heads are known to be useful to allow an operator to work in tight spaces and/or odd angles. The present invention includes a novel positioning assembly that allows a user to quickly move the head into a desired position and lock it in place so that the tool can complete the desired task.

### SUMMARY OF THE INVENTION

The present invention is hand tool with a positioning assembly for a locking flex head, which is defined according to the appended claims.

### BRIEF DESCRIPTION OF THE DRAWINGS

Features of the invention in accordance with one or more embodiments are shown in the drawings, in which like reference numerals

FIG. 1 is a perspective view of a locking flex head hand tool according to a first embodiment of the invention;

FIG. 2 is an exploded view of the locking flex head hand tool according to a first embodiment of the invention;

FIG. 3 is a cutaway view of the first embodiment of the locking flex head hand tool in a bent position, with inset details showing the positioning assembly in both the locked and unlocked configurations;

FIG. 4 is a perspective view of a locking flex head hand tool according to a second embodiment of the invention;

FIG. 5 is an exploded view of the locking flex head hand tool according to a second embodiment of the invention; and

FIG. 6 is a cutaway view of the second embodiment of the locking flex head hand tool in a bent position, with inset details showing the positioning assembly in both the locked and unlocked configurations.

### DETAILED DESCRIPTION OF THE ILLUSTRATED EMBODIMENT(S)

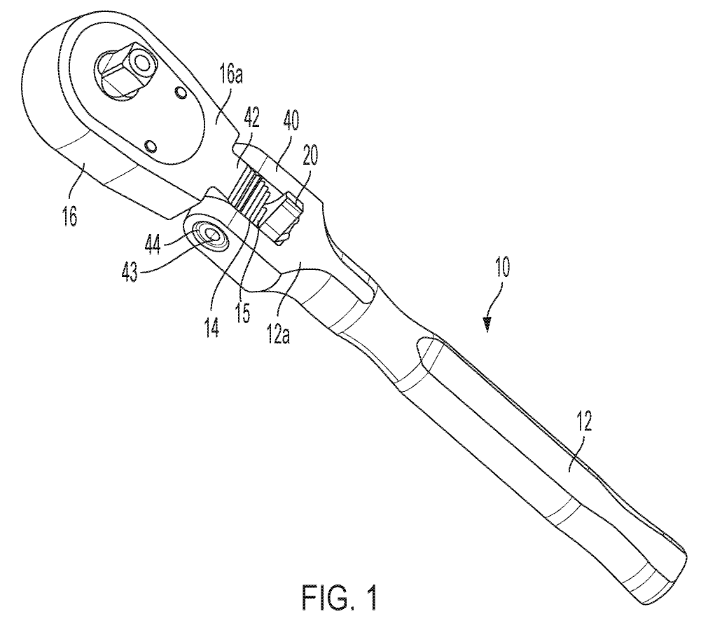

FIG. 1 shows a locking flex head hand tool 10, which includes a handle 12, a connecting ratchet 14 having a series of teeth 15, and a head 16 that is rotatably secured to the handle 12. The head 16 is configured to be ratcheted between a first position and a second position. The first position may be wherein a first side 16a of the head 16 is adjacent a first side 12a of the handle 12. The second position may be wherein a second side 16bof the head 16 is adjacent a second side 12b of the handle 12. In a preferred embodiment, the range between the first position and the second position may span 180 degrees or more.

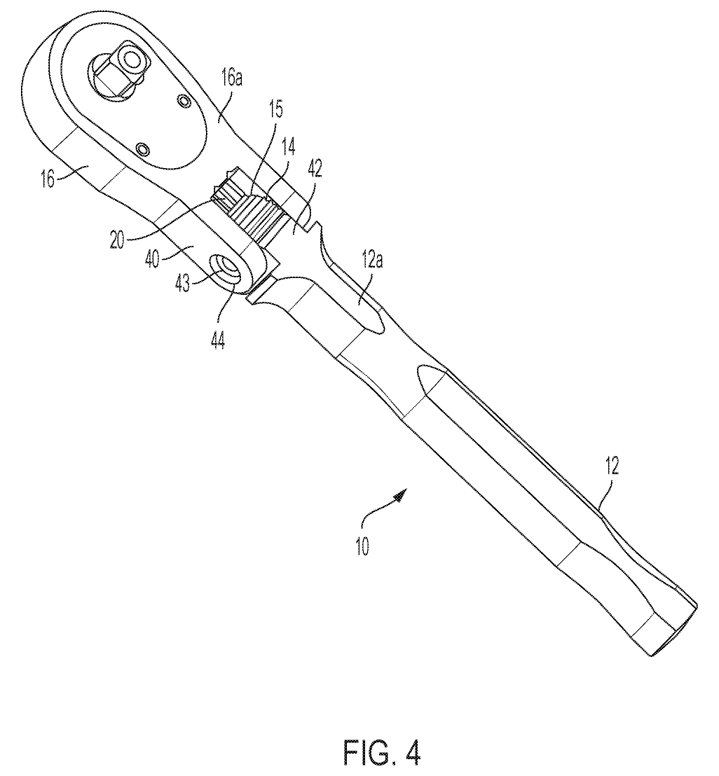

The hand tool 10 further comprises a positioning assembly 18 that is disposed between the head 16 and the handle 12. The positioning assembly 18 is configured to permit movement of the head 16 between the first and second position, or selectively lock the head 16 in either the first or second position or any ratcheted position therebetween. The positioning assembly 18 includes a selector 20 that is rotatable between a lock position and an unlock position. When the selector 20 is in the lock position, the head 16 is fixed in a desired position between the first and second positions. Conversely, when the selector 20 is in the unlock position, the head 16 is free to ratchet between the first and second positions. The selector 20 further defines a selector cavity 22 that has an internal rim 24 with at least one protrusion 26 that extends in a direction out of the selector cavity 22. As best seen in FIG. 4, the selector cavity 22 may be circular, thus making the internal rim 24 along with its protrusion 26, circular as well. In a preferable embodiment, the internal rim 24 may include two protrusions 26 that are spaced apart from one another.

In addition to the selector 20, the positioning assembly 18 also includes a gear slider 28 that is disposed within the selector cavity 22. The gear slider 28 has a first end 30 that is positioned toward the interior of the selector cavity 22, and a second end 32 that extends out of the selector cavity 22. The first end 30 further includes at least one protrusion 34 that is configured to selectively engage with at least one protrusion 26 of the internal rim 24. In a preferable embodiment, the gear slider 28 includes two protrusions 34 that are spaced apart from one another. When the selector 20 is in its lock position, the gear slider protrusion 34 is engaged to the internal rim protrusion 26 and axial movement of the gear slider 28 is limited. When the selector 20 is in its unlock position, the gear slider protrusion 34 is not engaged to the internal rim protrusion 26 and axial movement of the gear slider 28 is not limited. Instead, the gear slider 28 may move axially through a space defined by a distance D. The second end 32 of the gear slider 28 includes one or more teeth 36 configured to selectively have either locking or ratchet type engagement with the connecting ratchet teeth 15. When the selector 20 is in its lock position, the limited axial movement of the gear slider 28 causes locking engagement of the gear slider teeth 36 with the connecting ratchet teeth 15 thereby locking the head 16 in a desired position. Conversely, when the selector 20 is in its unlock position, the axial movement of the gear slider 28 through distance D permits ratchet type engagement of the gear slider teeth 36 with the connecting ratchet teeth 15 thereby allowing the head 16 to be ratcheted between the first and second position.

In addition to the selector 20 and gear slider 28, the positioning assembly further includes a biasing element 38. Biasing element 38 is disposed within the selector cavity 22 between the base 23 of the selector cavity 22 and the first end 30 of the gear slider 28. The biasing element 38 is configured to bias the gear slider 28 in a direction away or out of the selector cavity 22. When the selector 20 is in the unlock position, the permitted axial movement of the gear slider 28 and the bias of the biasing element 38 is what provides the familiar ratchet clicking sound as the gear slider teeth 36 repeatedly engage and disengage the connecting ratchet teeth 15.

We will now discuss two preferred embodiments. These embodiments are inverses of one another with respect to how they connect the head 16 to the handle 12. As such, we will use similar reference numerals to describe similar elements between the two embodiments).

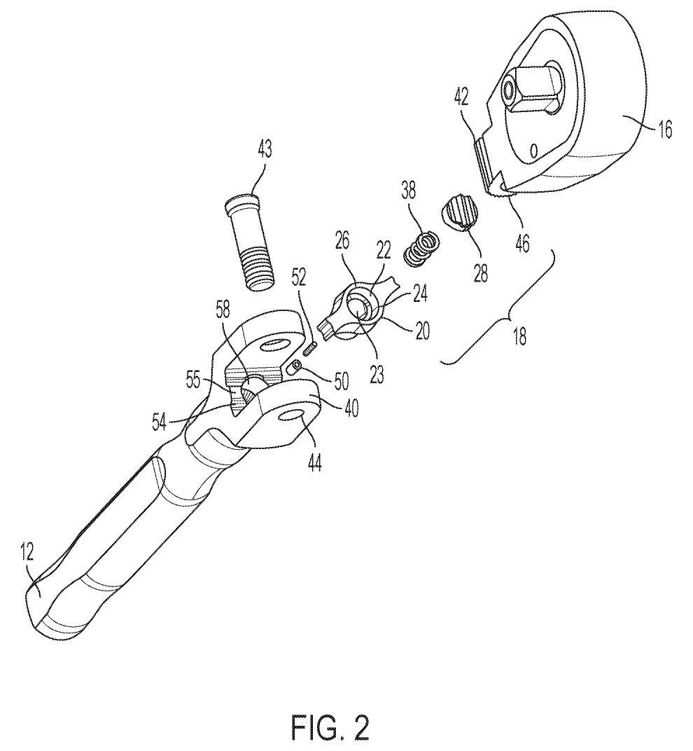

In a first embodiment, as shown in FIGS. 1-3, the handle 12 includes a pair of stirrups 40 that are configured to receive a rounded portion 42 of the head 16 therebetween. The rounded portion 42 further includes the connecting ratchet 14. Each stirrup 40 defines a cavity 44. The rounded portion 42 also defines a cavity 46. A fastener 43 may be configured to be disposed within the cavities 44 and 46 thereby securing the head 16 to the handle.

The hand tool 10 of this first embodiment may further include a selector locking mechanism 48 that includes a joint plunger 50, a biasing element 52 and one or more grooves 54 on a surface 55 between the stirrups 40 of the handle 12. The biasing element 52 may be disposed in a cavity defined by the selector 20. The biasing element 52 is positioned such that it biases the joint plunger 50 towards grooves 54.

In another feature of the first embodiment, the handle 12 defines a cavity 58 within which the selector 20 is be disposed.

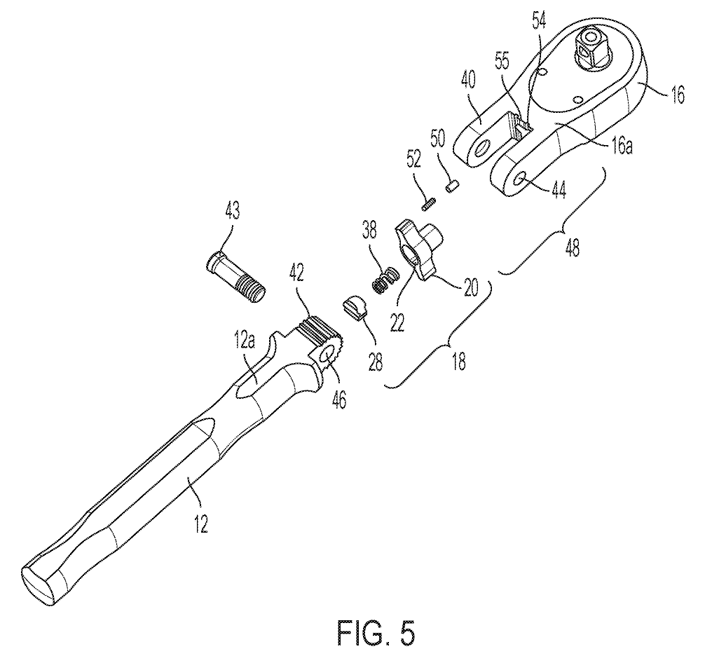

In a second embodiment, as shown in FIGS. 4-6, the head 16 includes a pair of stirrups 40 that are configured to receive a rounded portion 42 of the handle 12 therebetween. The rounded portion 42 of the handle 12 further includes the connecting ratchet 14. As with the first embodiment, each stirrup in the second embodiment also defines a cavity 44. The rounded portion also defines a cavity 46. A fastener 43 is configured to be disposed within cavities 44 and 46 thereby securing the head 16 to the handle 12.

The hand tool 10 of this second embodiment may further include a selector locking mechanism 48 that includes a joint plunger 50, a biasing element 52 and one or more grooves 54 on a surface 55 between the stirrups 40 of the head 16. The biasing element 52 may be disposed in a cavity 56 defined by the selector 20. The biasing element 52 is positioned such that it biases the joint plunger 50 towards grooves 54.

In another feature of the second embodiment, the head 16 defines a cavity 58 within which the selector 20 is disposed.

### INDUSTRIAL APPLICABILITY

We will now describe the industrial applicability of the present invention. While on a jobsite, it is often necessary to use a tool that can fit into odd or difficult to reach positions. In these situations, it may be preferable to use a tool that can selectively be bent or positioned into the desired or necessary position. For ease of description, the hand tool described herein and depicted in the Figures is that of a socket driver. While this is exemplary, those skilled in the art will recognize that the head 16 could include almost any other tool implement, such as a wrench (adjustable or standard), a ratchet, or even a screwdriver. Similarly, the handle 14 could also include almost any other tool implement.

When an operator desires to use the hand tool 10 of the present invention, she must first move the head 16 of the tool to the desired position, which may be at the first position, the second position or anywhere in between. In order to move the head 16, the selector 20 must be in its unlock position. Toggling the selector 20 from its lock position to its unlock position requires the operator to apply enough force to the selector 20, to overcome the selector lock mechanism 48. When this occurs, the the joint plunger 50 overcomes the force of its biasing element 52 and moves from one groove 54 across the surface 55 and into another nearby groove 54. Once the joint plunger 50 reaches the second groove 54, the force from biasing element 52 secures it in place in said groove 54.

The rotation of the selector 20 into its unlock position, also rotates the selector cavity 22 defined by the selector 20. As the selector cavity 22 rotates, the internal rim 22 and protrusions 24 thereon also rotate such that the protrusions 24 are no longer in engagement with the gear slider protrusions 34. Those skilled in the art will recognize that the engagement of the gear slider teeth 36 with the connecting ratchet teeth 15 will prevent the gear slider 28 from rotating while the selector 20 rotates between the lock and unlock positions.

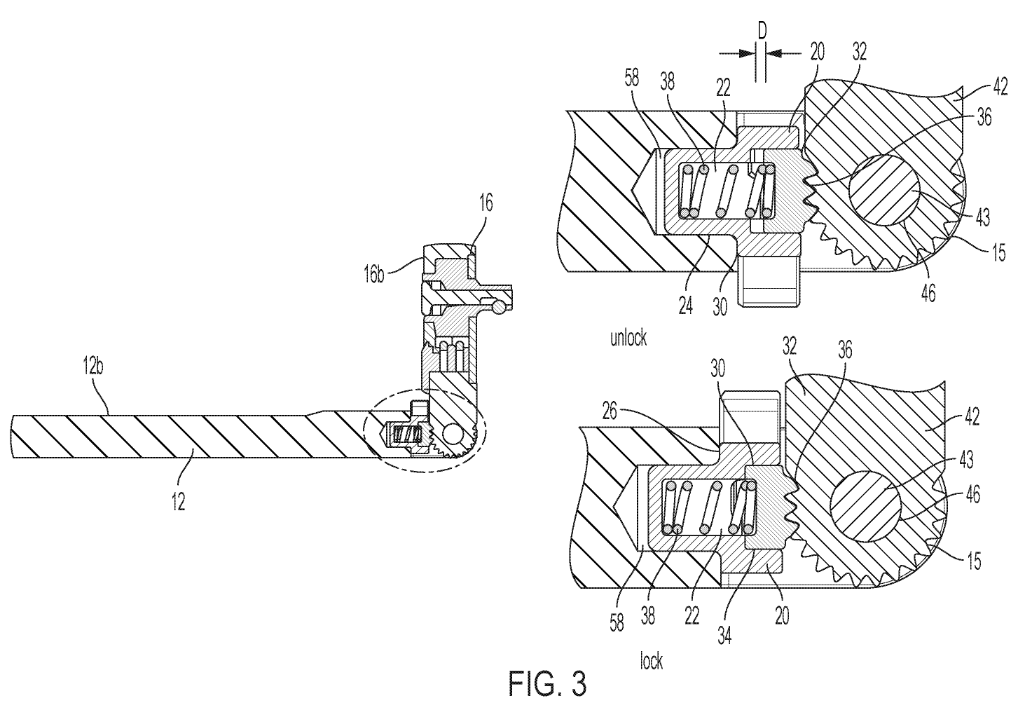

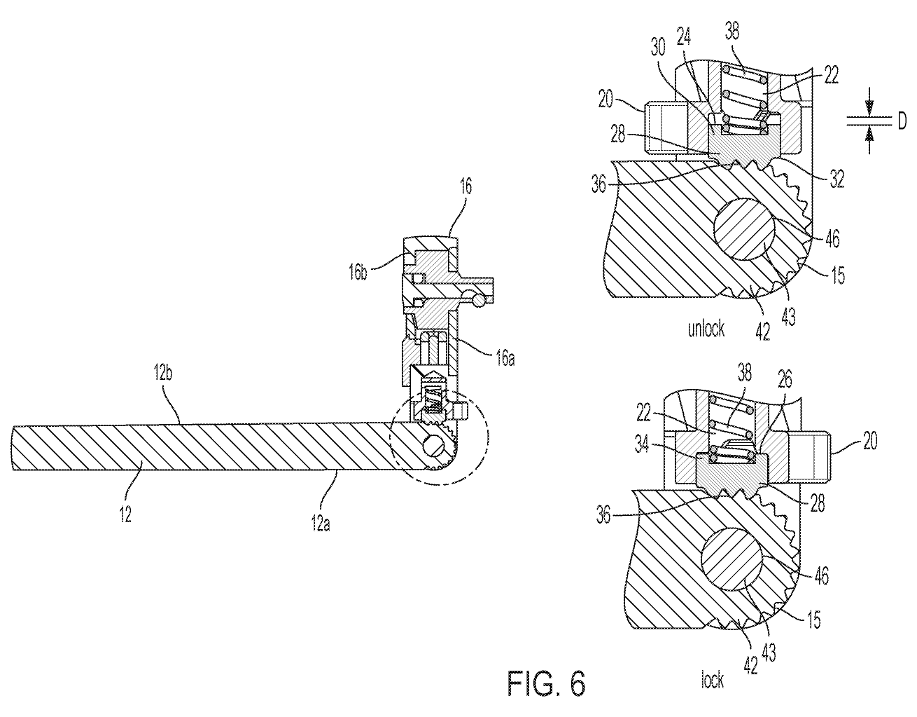

The rotation of the selector 20 into the unlock position causes the internal rim protrusions 26 to move out of engagement with the gear slider protrusions 34. The force applied by the biasing element 38 to the first end 30 of the gear slider 28 thus creates a space D wherein the gear slider 28 can move axially within the selector 20. (See the unlock inset in FIGS. 3 and 6). Space D is sized such that as the head 16 is rotated, the connecting ratchet teeth 15 push the gear slider 28 into space D until the enmeshed gear slider teeth 36 clear from the connecting ratchet teeth 15. As they clear, the head 16 rotates a bit and the biasing element 38 pushes the gear slider 28 back into engagement with the connecting ratchet 14. This ratcheting process is repeated until the head 16 reaches the desired position.

Once the head 16 reaches the desired position, the operator can lock it into position by toggling the selector 20 from the unlock position into the lock position. Those skilled the art will recognize that this process as it relates to the selector lock mechanism 48 is merely the reverse of that described above. Thus, it will not be repeated here.

The rotation of the selector 20 into its lock position causes the selector cavity 22 defined therein to also rotate. As this occurs, the internal rim protrusions 26 come back into engagement with the gear slider protrusions 34. This eliminates the space D between the gear slider 28 and selector 20. It also pushes the gear slider 28 into locking engagement with the connecting ratchet 14. (See the lock inset in FIGS. 3 and 6). With the head 16 now locked in the desired position, the operator can use the hand tool as desired.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

What is claimed is:

1. A hand tool comprising:
a handle,
a connecting ratchet having a series of teeth,
a head rotatably secured to the handle and configured to be ratcheted between a first position and a second position, and
characterized in that the hand tool further comprises a positioning assembly disposed between the head and the handle, and configured to permit movement of the head between the first and second position, or selectively lock the head in either the first or second position or any ratcheted position therebetween, and wherein the positioning assembly comprises:
a selector rotatable between a lock and unlock position, wherein said selector defines a selector cavity having an internal rim with at least one protrusion that extends out of the selector cavity,
a gear slider disposed within the selector cavity and having a first end positioned toward the interior of the selector cavity and a second end that extends away from the selector cavity, and wherein the first end includes at least one protrusion that is configured to selectively engage with at least one protrusion of the internal rim, such that when the selector is in its lock position, the gear slider protrusion is engaged to the internal rim protrusion and axial movement of the gear slider is limited, and when the selector is in its unlock position the gear slider protrusion is not engaged to the internal rim protrusion and axial movement of the gear slider is not limited, and wherein the second end of the gear slider includes one or more teeth configured to selectively have either locking or ratchet type engagement with the connecting ratchet teeth such that when the selector is in its lock position, the limited axial movement of the gear slider causes the gear slider teeth to have locking engagement with the connecting ratchet teeth thereby locking the head in a desired position, and when the selector is in its unlock position, the axial movement of the gear slider permits ratchet type engagement of the gear slider teeth with the connecting ratchet teeth thereby permitting the head to be ratcheted between the first and second position, and
a biasing element disposed within the selector cavity and biasing the gear slider out of the selector cavity.

2. The hand tool of claim 1, wherein the handle includes a pair of stirrups that are configured to receive a rounded portion of the head therebetween, and wherein the head is secured to the handle with a fastener that is disposed within cavities defined by the stirrups and the rounded portion, and wherein the rounded portion of the head includes the connecting ratchet.

3. The hand tool of claim 2, further comprising a selector locking mechanism that includes a joint plunger, a biasing element, and one or more grooves on a surface between the stirrups of the handle, and wherein the biasing element is disposed between the selector and the joint plunger such that the joint plunger is biased toward the grooves.

4. The hand tool of claim 3, wherein the selector further defines a cavity configured to receive the biasing element of the selector locking mechanism.

5. The hand tool of claim 1, wherein the handle further defines a cavity, within which the selector may be disposed.

6. The hand tool of claim 1, wherein the head includes a pair of stirrups that are configured to receive a rounded portion of the handle therebetween, and wherein the handle is secured to head with a fastener that is disposed within cavities defined by the stirrups and the rounded portion, and wherein the rounded portion of the handle includes the connecting ratchet.

7. The hand tool of claim 6, further comprising a selector locking mechanism that includes a joint plunger, a biasing element, and one or more grooves on a surface between the stirrups of the head, and wherein the biasing element is disposed between the selector and the joint plunger such that he joint plunger is biased towards the grooves.

8. The hand tool of claim 7, wherein the selector further defines a cavity configured to receive the biasing element of the selector locking mechanism.

9. The hand tool of claim 6, wherein the head further defines a cavity, within which the selector may be disposed.

10. The hand tool of claim 1, wherein the head further comprises a tool implement.

11. The hand tool of claim 1, wherein the handle further comprises a tool implement.
